(19) United States
(12) Patent Application Publication
(10) Pub. No.: US 2002/0155235 A1
(43) Pub. Date: Oct. 24, 2002

(54) Crosslinked coatings

(76) Inventors: James W. Taylor, Gurnee, IL (US); David E. Setzke, New Berlin, WI (US)

Correspondence Address: JOHNSON POLYMER, INC., 8310 16TH STREET- M/S 510, P.O. BOX 902, STURTEVANT, WI, 53177-0902, US

(21) Appl. No.: 09/781,635

(22) Filed: Feb. 13, 2001

(51) Int. Cl. B32B 1/02

(52) U.S. Cl. 428/35.7

(57) ABSTRACT

Coating compositions include polymeric particles, a crosslinking agent, and water. The polymeric particles include at least one incorporated monoalkenyl aromatic monomer, at least one incorporated vinyl-containing surfactant monomer, and at least one incorporated acrylic monomer. At least one incorporated acrylic monomer in the polymeric particles includes a hydroxyl, a carboxylic acid, or an amide functional group. The crosslinking agent is an aminoplast resin, preferably an organic aromatic compound that has at least two functional groups selected from (alkoxymethyl)(hydroxymethyl)amines, di(hydroxymethyl)amines, di(alkoxymethyl)amines, or combinations of these. Suitable crosslinking agents include hydroxymethyl and alkoxymethyl derivatives of melamine and other aminoplast resins. Preferably, the coating compositions include a curing catalyst such as an aromatic sulfonic acid or a salt of an aromatic sulfonic acid such as a zinc salt of dinonylnaphthalenesulfonic acid. Coating compositions may be deposited and cured by heating to form crosslinked coating compositions. Such crosslinked coating compositions exhibit excellent solvent resistance.

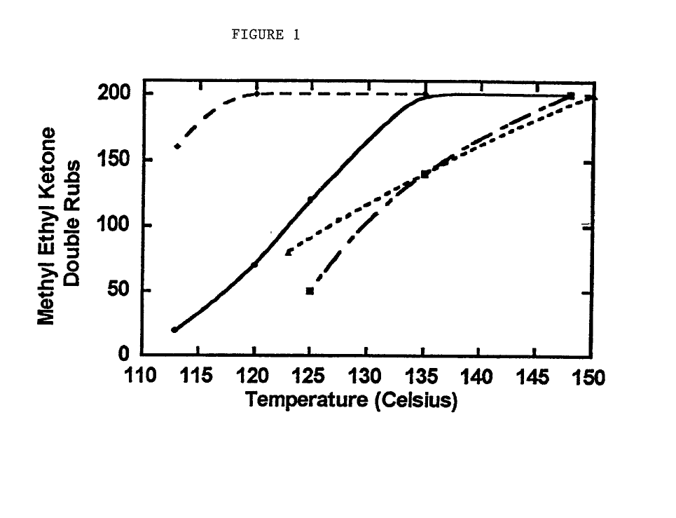

### FIELD OF THE INVENTION

The present invention relates to coating compositions, crosslinked coating compositions, coated substrates, and methods for producing the coating compositions and coated substrates. More particularly, the invention relates to coating compositions including polymeric particles and crosslinking agents where the polymeric particles incorporate a monoalkenyl aromatic monomer, a vinyl-containing surfactant monomer, and at least one acrylic monomer having a hydroxyl or carboxylic acid functional group.

### BACKGROUND OF THE INVENTION

Waterborne coatings are used to protect surfaces on numerous objects important to everyday life. For example, such coatings are commonly used to protect metals, wood, concrete, paper, and other important materials used in the construction of objects as diverse as homes, automobiles, bridges, retaining walls, and tin and aluminum cans.

Many surfaces such as metals are prone to oxidation, especially when exposed to salts, acids, bases, and other corrosive chemicals. Because waterborne coatings are used in a wide variety of applications and cover a wide variety of surface types, coatings that exhibit resistance to organic solvents, water, acids, salts, and other corrosive materials are highly desirable.

Although various waterborne coating compositions have been developed which show some degree of resistance to solvents and other chemicals, such coatings generally have a high cure temperature.

U.S. Pat. No. 4,814,514 and U.S. Pat. No. 4,939,283 issued to Yokota et al. disclose certain surface-active compounds which have a polymerizable allyl or methallyl group. The surface-active compounds are disclosed as being particularly useful as emulsifiers in the emulsion or suspension polymerization of various monomers such that aqueous suspensions of the polymer particles are produced.

U.S. Pat. No. 5,332,854 and U.S. Pat. No. 5,324,862 issued to Yokota et al. disclose anionic and nonionic vinyl-aromatic surfactants capable of reacting with other monomers, and thus being incorporated into polymers, during polymerization reactions.

Various vinyl aromatic surfactants referred to as Noigen RN, a nonionic surfactant, and Hitenol™ BC, an anionic surfactant, are described in a technical bulletin published by DKS International, Inc. of Tokyo, Japan. Related polymerizable anionic surfactants referred to as Hitenol™ A-10 are similarly described in another technical bulletin published by the same entity. Both publications disclose the preparation of polymers containing the surfactants.

U.S. Pat. No. 5,891,950 issued to Collins et al. disclose the preparation of water-based ink compositions containing a pigment and a polymer latex. The disclosed latex is either a non-carboxylic acid containing polymeric (polyamino) enamine latex or a mixture of a polymeric (polyamino) enamine latex and an acetoacetoxy-functional polymer latex. The polymeric (polyamino) enamine for use in the ink is disclosed as a reaction product of a surfactant-stabilized acetoacetoxy-functional polymer which may be prepared from a vinyl-containing anionic or nonionic reactive surfactant such as Hitenol™ RN, Hitenol™ HS-20, Hitenol™ A-10, and Noigen RN.

U.S. Pat. Nos. 6,060,556 and 5,998,543 issued to Collins et al. disclose the composition, preparation, and end-use of waterborne compositions prepared from water-based latexes. The water-based latexes comprise dispersed, non-carboxylic acid containing waterborne polymeric amino-functional and acetoacetoxy-functional particles. The disclosed latex can be used in a variety of coating compositions such as paints, inks, sealants, and adhesives. Preparation of a surfactant-containing acetoacetoxy-functional polymer is disclosed which may be prepared using a vinyl-containing anionic or nonionic reactive surfactant such as Hitenol™ RN, Hitenol™ HS-20, Hitenol™ A-10, and Noigen RN.

U.S. Pat. No. 6,028,155 issued to Collins et al. disclose the preparation and composition of surfactant-containing acetoacetoxy-functional polymers. The acetoacetoxy-functional polymers may be a surfactant-containing enamine-functional polymer, but is more preferably a surfactant-containing polymeric (polyamino) enamine. The disclosed non-carboxylic acid containing waterborne polymer compositions can be prepared with a high solids content while maintaining low viscosity, and the compositions are disclosed as useful in a variety of coating applications such as in paints, inks, sealants, and adhesives.

U.S. Pat. No. 5,539,073 issued to Taylor et al. discloses polymers useful in coating compositions. The polymers are prepared via free radical polymerization using ethylenically unsaturated monomers. Various reactive anionic and nonionic surfactants are disclosed as suitable surfactants for use in the disclosed emulsion polymerization process.

U.S. Pat. No. 5,783,626 issued to Taylor et al. discloses allyl-functional polymers having pendant enamine moieties and preferably also possessing pendant methacrylate groups. The patent also discloses that amino-containing waterborne particles can be prepared by reacting propylene imine with carboxylic acid-containing latexes. Such amino-functionalized latexes were reacted with acetoacetoxyethyl methacrylate. Vinyl-containing anionic and ionic surfactants are disclosed as components which can be added to processes used for preparing the acetoacetoxy-containing polymers.

Although a number of references have disclosed polymerizable surfactants and polymers incorporating such surfactants, none of the references discloses a coating composition that comprises a crosslinking agent and a polymeric particle prepared from a vinyl-containing surfactant monomer that exhibits enhanced solvent resistance when crosslinked at low cure temperatures or such a coating composition which cures at faster line speeds at higher temperatures.

### SUMMARY OF THE INVENTION

It would be highly desirable to have a coating composition that exhibits increased solvent resistance at lower cure temperatures.

The invention provides coating compositions that include polymeric particles, a crosslinking agent, and water. The polymeric particles include at least one incorporated monoalkenyl aromatic monomer, at least one incorporated vinyl-containing surfactant monomer, and at least one incorporated acrylic monomer. At least one incorporated acrylic monomer includes a hydroxyl functional group, a carboxylic acid functional group, or an amide functional group. The crosslinking agent is an aminoplast resin. More preferred coating compositions are provided in which the aminoplast resin is an organic aromatic compound, preferably a melamine derivative, having at least two functionalities selected from di(hydroxymethyl)amines, (alkoxymethyl)(hydroxymethyl)amines, di(alkoxymethyl)amines, or combinations of these. In other coating compositions, the polymeric particles incorporate at least one acrylic monomer with a hydroxyl or carboxylic acid functional group.

Further coating compositions are provided which include a curing catalyst, preferably an aromatic sulfonic acid or a salt of an aromatic sulfonic acid. In some preferred coating compositions, the curing catalyst is benzenesulfonic acid, p-toluenesulfonic acid, dinonylnaphthalenesulfonic acid, or salts or mixtures of these. In still other coating compositions, the curing catalyst is a transition metal salt, preferably zinc, of an aromatic sulfonic acid, preferably a zinc salt of dinonylnaphthalenesulfonic acid.

A method of preparing a coating composition includes mixing polymeric particles with a crosslinking agent to produce the coating composition. The polymeric particles include at least one incorporated monoalkenyl aromatic monomer, at least one incorporated vinyl-containing surfactant monomer, and at least one incorporated acrylic monomer. At least one incorporated acrylic monomer of the polymeric particles includes a hydroxyl functional group, a carboxylic acid functional group, or an amide functional group. The crosslinking agent is an aminoplast resin. Preferred methods include an aminoplast resin that is an organic aromatic compound, more preferably a derivative of melamine, having at least two functionalities selected from di(hydroxymethyl)amines, di(alkoxymethyl)amines, (alkoxymethyl)(hydroxymethyl)amines, or combinations of these.

The invention also provides a method for preparing a coated substrate that includes coating a substrate with a coating composition according to the present invention.

The invention further provides coated substrates that include a substrate, preferably metal, coated with a coating composition according to the present invention. One such coated substrate includes a can, and an interior of the can is coated with a coating composition according to the present invention. Coated substrates are also provided that include a substrate coated with a crosslinked coating composition according to the present invention.

The invention also provides kits for preparing coating compositions that include polymeric particles and a crosslinking agent. The polymeric particles include at least one incorporated monoalkenyl aromatic monomer, at least one incorporated vinyl-containing surfactant monomer, and at least one incorporated acrylic monomer. At least one incorporated acrylic monomer of the polymeric particle includes a hydroxyl functional group, a carboxylic acid functional group, or an amide functional group. The crosslinking agent of the kit is an aminoplast resin which preferably is an organic aromatic compound that has at least two functionalities selected from (alkoxymethyl)(hydroxymethyl)amines, di(hydroxymethyl)amines, di(alkoxymethyl)amines, or combinations of these. The invention also provides kits that include a curing catalyst in addition to the components described above.

The invention further provides waterborne compositions that include water, polymeric particles, a crosslinking agent, and a zinc salt of dinonylnaphthalenesulfonic acid.

Still further features and advantages of the invention will be apparent from the following detailed description.

### BRIEF DESCRIPTION OF THE DRAWING

The FIGURE is a graph showing the number of methyl ethyl ketone double rubs for four coating compositions as a function of cure temperature. In the FIGURE, ● represents the coating composition prepared in Example 3 using the polymeric particles prepared in Example 1; ▪ represents the coating composition prepared in Example 3 using the conventional polymeric particles prepared in Example 2; ♦ represents the coating composition prepared in Example 3 using the polymeric particles prepared in Example 1 with added curing catalyst; and [symbol] represents the coating composition prepared in Example 3 with the conventional polymeric particles prepared in Example 2 with added curing catalyst.

### DETAILED DESCRIPTION OF THE INVENTION

A polymeric particle “substantially free” of an item is a polymeric particle that contains less than 2%, more preferably less than 1%, and most preferably less than 0.25% (w/w) of the item.

A coating composition “substantially free” of an item is a coating composition that contains less than 0.5% (w/w) of the item.

A polymeric particle that has a monomer “incorporated” into it means that the monomer has reacted in a polymerization reaction and that the reacted monomer is physically present in the polymeric particle.

A coating composition with a polymeric particle incorporating a vinyl-containing surfactant monomer “exhibits enhanced solvent resistance” when the number of methyl ethyl ketone double rubs for the cured coating is greater than that of a cured coating composition prepared under identical conditions except that the polymeric particle does not incorporate a vinyl-containing surfactant monomer, but rather where the coating composition includes the surfactant sodium dioctyl sulfosuccinate.

All ranges recited herein include all combinations and subcombinations included within that range's limits. Therefore, a range from “5-90%” includes ranges from “5-72%”, “12-65%”, etc. A range of “greater than 100° C.” would include “greater than 112° C.”, “greater than 150° C.”, etc.

Generally, coating compositions according to the invention include a polymeric particle, a crosslinking agent, and water. Typically, the polymeric particles are prepared by an emulsion polymerization so that the polymeric particles are obtained as an aqueous dispersion. The polymeric particles of the coating composition include at least one incorporated monoalkenyl aromatic monomer, at least one incorporated vinyl-containing surfactant monomer, and at least one incorporated acrylic monomer. At least one incorporated acrylic monomer of the polymeric particle includes a hydroxyl functional group, a carboxylic acid functional group, or an amide functional group. The crosslinking agent is an aminoplast resin, that is preferably an organic aromatic compound which still more preferably includes at least two functionalities selected from di(hydroxymethyl)amines, di(alkoxymethyl)amines, (alkoxymethyl)(hydroxymethyl)amines, or combinations of these. Still more preferably, the aminoplast resin is a melamine derivative.

The polymeric particle for use in the method of the present invention incorporates at least one vinyl-containing surfactant monomer. The vinyl-containing surfactant monomer is preferably a vinyl aromatic surfactant monomer and more preferably is a vinyl aromatic anionic or nonionic surfactant monomer. Preferred vinyl-containing surfactant monomers for use in the present invention have the structure:

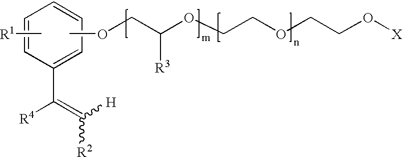

where: R¹ is H, a halogen, or a C₁ to C₂₂ linear or branched chain hydrocarbon group; R² is H, a halogen, or a linear or branched chain C₁ to C₆ linear or branched chain hydrocarbon and the zigzag lines represent that the R₂ group can be either cis or trans to the aromatic group; R³ is H, a halogen, or a C₁ to C₆ linear or branched chain hydrocarbon group; R⁴ is H or a C₁ to C₄ alkyl group; m is an integer ranging from 0 to 20; n is an integer ranging from 1 to 50; X is H, SO₃⁻Y, P(═O)(OH)₂, or a deprotonated form of P(═O)(OH)₂; and Y is a cation such as sodium, lithium, potassium, ammonium, monoalkylammonium, dialkylammonium, trialkylammonium, or tetralkylammonium. More preferred vinyl-containing surfactant monomers for use in the present invention include those where m is 0 or 1; n is an integer from 5 to 25, more preferably 14 to 25; R² is a methyl or H; R³ is H; R⁴ is H; and X is SO₃⁻Y. In still more preferred vinyl-containing surfactant monomers n is 19, m is 0, and Y is an ammonium, a monoalkylammonium, a dialkylammonium, a trialkylammonium, or a tetraalkylammonium cation. In still other preferred vinyl-containing surfactant monomers, the vinyl-group of the vinyl-containing surfactant monomer is ortho to the alkoxy group bonded to the aromatic ring of the vinyl-containing surfactant monomer.

The polymeric particles in the coating compositions of the present invention incorporate at least one acrylic monomer and at least one monoalkenyl aromatic monomer in addition to incorporating at least one vinyl-containing surfactant monomer. At least one acrylic monomer incorporated in the polymeric particle preferably has a hydroxyl or carboxylic acid functional group. More preferred particles in the coating of the present invention incorporate at least one vinyl-containing surfactant monomer, at least two different acrylic monomers, and at least one monoalkenyl aromatic monomer. In especially preferred embodiments, the polymeric particles incorporate at least one acrylic monomer having a hydroxyl group such as, for example, hydroxyalkyl acrylates and hydroxyalkyl methacrylates.

Various acrylic monomers may be incorporated in the polymeric particle used in the present invention. Examples of acrylic monomers include, but are not limited to, acrylic acid, methacrylic acid, crotonic acid, esters of acrylic acid, esters of methacrylic acid, esters of crotonic acid, salts of acrylic acid, salts of methacrylic acid, and salts of crotonic acid. These are all examples of acrylic monomers including a carboxylic acid group.

Examples of acrylate and methacrylate monomers that may be incorporated in the polymeric particle include, but are not limited to, methyl, ethyl, n-propyl, i-propyl, n-butyl, s-butyl, i-butyl, t-butyl, n-amyl, i-amyl, n-hexyl, 2-ethylbutyl, 2-ethylhexyl, n-heptyl, n-octyl, n-nonyl, n-decyl, cyclopentyl, cyclohexyl, benzyl, phenyl, cinnamyl, 2-phenylethyl, allyl, methallyl, propargyl, crotyl, 2-hydroxyethyl, 2-hydroxypropyl, 2-hydroxybutyl, 6-hydroxyhexyl, 5,6-dihydroxyhexyl, 2-methoxybutyl, 3-methoxybutyl, 2-ethoxyethyl, 2-butoxyethyl, 2-phenoxyethyl, glycidyl, furfuryl, tetrahydrofurfuryl, tetrahydropyryl, N,N-dimethylaminoethyl, N,N-diethylaminoethyl, N-butylaminoethyl, 2-chloroethyl, 3-chloro-2-hydroxypropyl, trifluoroethyl, and hexafluoroisopropyl acrylates and methacrylates. More preferred acrylates and methacrylates include alkyl acrylates and methacrylates such as the various isomers of methyl, ethyl, propyl, butyl, pentyl, hexyl, heptyl, octyl, n-nonyl, and n-decyl acrylates and methacrylates. Other preferred acrylates and methacrylates include hydroxyalkyl acrylates and methacrylates such as, but not limited to 2-hydroxyethyl and 3-hydroxypropyl acrylate and methacrylate. Particularly preferred acrylic monomers for incorporation into the polymeric particles of the coating compositions according to the invention include 2-hydroxyethyl acrylate, 2-hydroxyethyl methacrylate, 2-ethylhexyl acrylate, and methacrylic acid.

Although, as described above, a large number of different acrylic monomers may be incorporated into the polymeric particles, a particularly useful combination of acrylic monomers for incorporation into a polymeric particle include 2-ethylhexyl acrylate, 2-hydroxyethyl acrylate, and methacrylic acid. These are especially preferred when combined with monomers such as styrene, α-methylstyrene, or both. When used to prepare the polymeric particles, the following monomers are used in the following amounts where the ranges in parentheses respectively indicate the preferred range, the more preferred range, and the most preferred range of the monomer used by weight based on the total weight of the monomers: styrene (5-90%; 20-70%; 40-60%); methyl methacrylate (5-90%; 20-70%; 40-60%); 2-ethylhexyl acrylate (5-90%; 20-70%; 22-33%); ethyl acrylate (5-90%; 20-60%, 30-50%); hydroxyethyl acrylate (3-30%; 6-20%; 8-16%); hydroxyethyl methacrylate (3-30%; 6-20%; 8-16%); methacrylic acid (0-20%; 6-20%; 0-5%); vinyl-containing surfactant monomer (0-10%; 0.5-5%; 1-2%); octyl mercaptopropionate (0-5%; 0-1%; 0-0.1%); and butyl acrylate (5-90%; 20-70%; 25-45%).

A variety of monoalkenyl aromatic monomers may be incorporated in the polymeric particle for use in the present invention. For example, suitable monoalkenyl aromatic monomers include, but are not limited to styrene, vinyltoluene, α-methyl styrene, t-butyl styrene, vinylxylene, and vinylpyridine. More preferred monoalkenyl aromatic monomers include styrene and α-methyl styrene. Although some of the vinyl-containing surfactant monomers incorporated in the polymeric particle are aromatic vinyl-containing surfactant monomers and could thus be classified as a type of monoalkenyl aromatic monomer, the term “monoalkenyl aromatic monomer” as used herein is defined to not include the vinyl-containing surfactant monomers.

A variety of other monomers may be incorporated in the polymeric particle for use in the present invention. One such monomer that may be incorporated in the polymer includes vinyl ester monomers. Preferred vinyl esters include, but are not limited to, those having the structure H₂C═C(R¹¹)—O—C(═O)—R¹² where R¹¹ is either H or an alkyl group having from 1 to 5 carbon atoms and R¹² is an alkyl group having from 1 to 22 carbon atoms. In a more preferred embodiment, at least one of the carbon atoms of the R¹² alkyl group is bonded to at least three other carbon atoms. Thus, more preferred vinyl ester monomers include those with a tertiary or quaternary carbon in the R¹² alkyl group. Examples of a few of these more preferred vinyl ester monomers include, but are not limited to: H₂C═C(R¹¹)—O—C(═O)—C(CH₃)₃, H₂C═C(R¹¹)—O—C(═O)—CH₂—(CH₃)₃, H₂C═C(R¹¹)—O—C(═O)—CH(CH₃)—CH₂—CH₃, H₂C═C(R¹¹)—O—C(═O)—CH₂—C(CH₃)₂—CH₂—CH₂—CH₂—CH₃, and H₂C═C(R¹¹)—O—C(═O)—C(CH₃)₂—CH₂—CH₃.

It is not necessary or required that the polymeric particle for use in the coating compositions contain metal chelating groups such as acetoacetoxy, amine, or enamine groups. Rather, it has been found that metal surfaces coated with coating compositions including a crosslinking agent and polymeric particles that do not contain these groups exhibit enhanced resistance to organic solvents even when cured at relatively low cure temperatures such as about 110° C. However, these groups may be present if so desired. The fact that these groups can be excluded from the polymeric particles for use in the present invention helps to reduce the costs associated with using monomers such as acetoacetoxyethyl methacrylate. Furthermore, because the polymeric particles do not require any polymeric amine or enamine, acid-functional acrylic monomers such as, but not limited to, acrylic acid, methacrylic acid, and crotonic acid may be incorporated without any resulting cloudiness or flocculation. The polymeric particle need also not contain trimethylolpropane as coating compositions containing polymers prepared without this material have shown excellent solvent resistance on surfaces.

The coating compositions of the present invention include a crosslinking agent. The crosslinking agent is an aminoplast resin. Aminoplast resins are typically organic compounds with amine or amide functional groups that have been reacted with an aldehyde such as formaldehyde to produce compounds with hydroxymethyl groups which may be capped with alkyl or other such groups in some aminoplast resins. Examples of amines and amides generally used to produce aminoplast resins include, but are not limited to, urea, melamine, and benzoguanamine. Any aminoplast resin may be used in the compositions and methods of the present invention. Preferably, however, the crosslinking agents are aminoplast resins that are organic aromatic compounds more preferably those that have at least two functionalities selected from di(hydroxymethyl)amines, (alkoxymethyl)(hydroxymethyl)amines, di(alkoxymethyl)amines, or combinations of these. Examples of such crosslinking agents include, but are not limited to, derivatives of di- and tri-amino pyrimidines, di- and tri-amino pyridines, di- and tri-amino triazines, di- and tri-amino benzene, di- and tri-amino toluene, and di- and tri-amino xylenes. More preferred crosslinking agents include substituted 1,3,5-triazines substituted with at least two functionalities selected from di(hydroxymethyl)amines, (alkoxymethyl)(hydroxymethyl)amines, di(alkoxymethyl)amines, or combinations of these. Examples of some of these include, but are not limited to, derivatives of melamine (2,4,6-triamino-1,3,5-triazine), derivatives of benzoguanamine (2,4-diamino-6-phenyl-1,3,5-triazine), and derivatives of acetoguanamine (2,4-diamino-6-methyl-1,3,5-triazine). Even more preferred crosslinking agents are the condensation product of the reaction of melamine with six aldehyde molecules. Still more preferred crosslinking agents

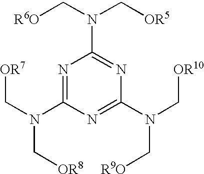

where R⁵, R⁶, R⁷, R⁸. R⁹ and R¹⁰ may be the same or different and are independently selected from H, or alkyl groups having from 1-4 carbon atoms. Especially preferred crosslinking agents for inclusion in the coating compositions are those with the above structure where R⁵, R⁶, R⁷, R⁸. R⁹ and R¹⁰ are either all H or all methyl groups. Cymel® 303, a brand of melamine-based crosslinking agent available from Solutia of St. Louis, Mo., is one example of a preferred crosslinking agent for use in the present invention where R⁵ through R¹⁰ are each methyl groups.

Upon exposure to heat, the di(hydroxymethyl)amine, (alkoxymethyl)(hydroxymethyl)amine, and/or di(alkoxymethyl)amine groups of the preferred crosslinking agents react with the hydroxyl or carboxylic acid functional groups of the hydroxyl-functional or carboxylic acid-functional acrylic monomer incorporated in the polymeric particle to produce crosslinked coatings that exhibit enhanced resistance to water, organic solvents, acid solutions, and other chemicals. Polymeric particles containing amide groups will also react with the crosslinking agent so the polymeric particles may incorporate an acrylic monomer containing this functionality in place of or in addition to the acrylic monomers with the hydroxyl or carboxylic acid group. However, polymeric particles incorporating acrylic monomers with hydroxyl or carboxylic acid functional groups are preferred. Examples of amide-containing acrylic monomers that may be used include, but are not limited to acrylamide and methacrylamide.

The polymeric particle for use in the present invention may be prepared using any method known to those skilled in the art for incorporating radically-polymerizable ethylenically-unsaturated monomers into a polymer. The polymer may be prepared by continuous, semi-batch or batch processes using any type of reactor known to those skilled in the art. Various polymerization processes are disclosed in U.S. Pat. No. 4,414,370, U.S. Pat. No. 4,529,787, and U.S. Pat. No. 4,546,160 and these patents are herein expressly incorporated by reference in their entirety.

The polymeric particle may also be prepared by emulsion polymerization techniques and methods known to those skilled in the art. For example, a suitable latex containing incorporated vinyl-containing surfactant monomer may be prepared by adding a standard initiator such as, but not limited to, ammonium persulfate to an aqueous heated solution of a vinyl-containing surfactant monomer such as Hitenol™ BC-20 available from DKS International, Inc. (Tokyo, Japan) while it is stirred in a resin kettle. A monomer feed containing additional monomers may then be added to the resulting mixture. For example, an emulsion feed containing more of the vinyl-containing surfactant monomer; acrylic monomers such as a mixture of methacrylic acid, 2-hydroxyethyl acrylate and 2-ethylhexyl acrylate; and an monoalkenyl aromatic monomer such as styrene or a mixture of monoalkenyl aromatic monomers, may be added to the solution.

The monomer feed may contain additional components such as, but not limited to, solvents and chain transfer agents. For example, any conventional chain transfer agent such as octyl mercaptopropionate may be present in the monomer feed. Once monomer addition is complete, oxidants such as ferrous sulfate may be added to the mixture followed by addition of initiators such as t-butyl hydroperoxide dissolved in aqueous solution containing isoascorbic acid and ammonium hydroxide. The pH of the aqueous product is generally increased to value of greater than about 8 by addition of ammonium hydroxide solution. Preferred coating compositions prepared from aqueous dispersion containing the polymeric particles generally have a pH of greater than 7 and less than about 10. More preferably, the pH of the coating composition is greater than 8 or about 8.

The coating compositions may be prepared by mixing polymeric particles according to the invention with a crosslinking agent according to the invention. Preferred methods for preparing coating compositions additionally include adding a curing catalyst to the coating composition. The ratio of polymeric particles to crosslinking agent by weight preferably ranges from 95:5 to 55:45, more preferably from 90:10 to 60:40, still more preferably 80:20 to 65:35. An especially preferred coating composition is obtained using a ratio of polymeric particles to melamine-based crosslinking agent of 70:30 by weight. If a curing catalyst is added, it may be added before the other polymeric particles and the crosslinking agent are mixed. Preferably, if a curing catalyst is added to a coating composition it is added either directly to the polymeric particles or as a blend that contains the crosslinking agent and the curing agent.

Addition of a curing catalyst to a coating composition comprising a crosslinking agent of the invention and a polymeric particle comprising at least one incorporated monoalkenyl aromatic monomer, at least one incorporated acrylic monomer, and at least one incorporated vinyl-containing aromatic monomer produces coating compositions that show excellent solvent resistance even when cured at temperatures of 113° C. However, the improved solvent resistance upon addition of the catalyst is also observed at higher temperatures. These catalysts are preferably aromatic sulfonic acid such as, but not limited to, benzenesulfonic acid, p-toluenesulfonic acid, dinonylnaphthalenesulfonic acid or salts of such aromatic sulfonic acid such as sodium, potassium, or lithium salts or salts of transition metals such as cobalt or zinc, most preferably zinc. Particularly preferred curing catalysts include zinc salts of p-toluenesulfonic acid and of dinonylnaphthalenesulfonic acid. A most preferred catalyst is Nacorr® 1552, a brand of the zinc salt of dinonylnaphthalenesulfonic acid available from King Industries of Norwich, Conn. Solvent resistance was measured using methyl ethyl ketone (MEK) double rubs as explained in Example 4. The FIGURE shows the significantly improved solvent resistance of the coating compositions of the present invention compared to those containing conventional polymeric particles. Furthermore, the FIGURE shows the significant improvement in solvent resistance that occurs upon addition of a curing catalyst to the coating compositions. If added, the curing catalyst is preferably present in an amount ranging from about 0% to about 3% by weight, more preferably in an amount ranging from about 0% to about 1%, still more preferably in an amount of about 0.25%. Preferably, polymeric particles are mixed with the crosslinking agent at about room temperature or a temperature ranging from about 21° C. to about 25°. Thus, surprisingly and unexpectedly, it has been discovered that improved waterborne compositions and coatings may be prepared that include water, polymeric particles, a crosslinking agent, and the zinc salt of dinonylnaphthalenesulfonic acid.

Mixing of the polymeric particles with the crosslinking agent and optionally, but preferably, the curing catalyst may be accomplished using any well known agitation method known to those skilled in the art. Thus, the mixing may be accomplished with a blender or any other high speed mixing device. Generally, introduction of the crosslinking agent and curing catalyst involves preblending the crosslinking agent with a water miscible solvent that may include water. The curing catalyst may then be added to the blend containing the crosslinking agent or may be added directly to the polymeric particles. The blend containing the crosslinking agent is typically added to the polymer particles while agitated using any high speed mixing apparatus as described above. Blade speeds of 50 revolutions per minute or higher are generally preferred. If the curing catalyst is added directly to the polymeric particles rather than to the blend, agitation speeds of greater than 50 revolutions per minute are generally preferred.

A coated substrate may be prepared by coating a substrate with a coating composition according to the present invention. The coating may then be allowed to dry at room temperature or may be dried at elevated temperature. A coated substrate having a crosslinked coating composition is typically prepared by heating (curing) the coated substrate to a temperature of greater than about 100° C., more preferably to a temperature of greater than about 110° C., or even more preferably to a temperature of from 113° C. to about 200° C. It has been discovered that the temperature plays an important role in determining the solvent and chemical resistance of a coating on a substrate. As described above, it has also been discovered that the presence of a curing catalyst such as the zinc salt of dinonylnaphthalenesulfonic acid greatly improves the solvent and acid resistance of coatings. This allows the curing temperature to be lowered while still obtaining the same solvent resistance afforded at higher cure temperatures.

Various substrates may be coated with the coating compositions of the invention. A preferred coated substrate is a metal such as, but not limited to, aluminum, copper, tin, steel, or iron coated with a coating composition according to the present invention. Other substrates that may be coated include plastic and paper surfaces. Particularly preferred coated substrates are coated aluminum and steel. The substrate can take various forms. For example, a particularly preferred coated substrate is a can, preferably an aluminum can such as those used in conjunction with carbonated beverages where an interior of the can is coated with a coating composition according to the present invention.

Kits for use in preparing a coating composition include any polymeric particle of the invention and any crosslinking agent of the invention. Preferred kits also contain a curing catalyst such as those described above.

The coating composition may be applied to a metal or any other surface using any technique known to those skilled in the art. Thus, the polymeric particle may be applied to a metal surface as a clear coat formulation. Alternatively, the polymeric particle may be applied as one of several components in a paint. Such paints can be readily prepared by mixing a latex prepared as described above with a number of ingredients using conventional techniques. For example, the latex may be mixed with water, a conventional pigment such as, but not limited to, TiPure™ R-706 TiO₂ pigment or TiPure™ R-900 TiO₂ pigment, both available from E.I. DuPont de Nemours (Wilmington, Del.) and various conventional additives such as, but not limited to, organic solvents, defoamers, conventional surfactants, associative thickeners, plasticizers, flash rust inhibitors, and dispersants. Non-limiting representative examples of some of these components are CT-324 dispersant available from Air Products (Allentown, Pa.); Surfynol® CT-151 dispersant available from Rohm and Haas Company (Philadelphia, Pa.); Surfynol® 104DPM conventional surfactant available from Rohm and Haas Company (Philadelphia, Pa.); BYK 020 defoamer available from BYK Chemie (Wallingford, Conn.); Dehydran® 1620 defoamer available from Henkel Corp. (Ambler, Pa.); ®PUR 40 an associative thickener available from King Industries, Inc. (Norwalk, Conn.); DSX®-1550 associative thickener available from Henkel Corp. (Ambler, Pa.); RM-825™ associative thickener available from Rohm and Haas Company (Philadelphia, Pa.); Ektasolve® EB, a brand of 2-butoxyethanol available from Eastman Chemical (Kingsport, Tenn.); Butyl Cellosolve® diethylene glycol monobutyl ether and/or Hexyl Carbitol® diethylene glycol monohexyl ether both available from Union Carbide (Danbury, Conn.); KP-140® tributoxy ethyl phosphate available from FMC Corp. (Philadelphia, Pa.); and Raybo™ 60 flash rust inhibitor available from Raybo Chemical Company (Huntington, W. Va.). In addition, one skilled in the art will recognize that other types of polymeric particles may be included in the coating compositions of the present invention. For example, polymeric particles that do not incorporate acrylic monomers with hydroxyl functional groups, carboxylic acid functional groups, or amide functional groups may be mixed with polymeric particles that do incorporate such acrylic monomers to produce coating compositions that include two or more types of polymeric particles.

Surprisingly and unexpectedly, it has been found that coating compositions comprising a polymeric particle incorporating vinyl-containing surfactant monomer(s) and a crosslinking agent show drastically improved solvent resistance and resistance to aqueous acid solutions compared to similar coating compositions that contain polymers without incorporated vinyl-containing surfactant monomers, but rather contain conventional surfactants. It has been found that the solvent resistance for the coating compositions that contain crosslinking agents such as the preferred crosslinking agents of the invention may be better than those with a conventional surfactant, but without the incorporated vinyl-containing monomer, even when the cure temperature of the coating is lower for the compositions prepared from the vinyl-containing surfactant monomer.

The coating compositions may be applied to a substrate using any technique known to those skilled in the art including, but not limited to, spray coating, brush coating, powder coating, and application with applicator blades.

The coating compositions applied to substrates are generally in an aqueous polymeric dispersion such as, but not limited to, a latex. However, the polymeric particles and crosslinking agents may also be dissolved in an organic solvent and thus applied to the surface. Thus, the coating composition of the invention may be painted on a substrate surface using any of various techniques known to those skilled in the art. Additionally, the coating composition may be applied in other forms including, but not limited to, as a powder coating. A solution containing the polymeric particles for application to the substrate may contain various other ingredients as described above and demonstrated below.

The coating compositions of the present invention may be formulated as clear coats, as paints, as inks, as coating for textiles, and as coatings for wood.

### EXAMPLES

### Example 1

### Preparation of a Latex Using Vinyl-Containing Surfactant Monomer

To a 3000 mL resin kettle equipped with a nitrogen purge, three-blade impeller, and condenser were charged 521 g of water and 11.5 g of a 10% solution of Hitenol™ BC-20 a brand of vinyl-containing reactive surfactant monomer available from DKS International, Inc. (Tokyo, Japan). The surfactant solution was heated to 80° C. with stirring, then 3.2 g of ammonium persulfate dissolved in 40 g of water was pumped into the reactor over 5 minutes followed by addition of 7.5 g of water. An emulsion feed of 280 g of water, 6.65 g of Hitenol™ BC-20 (100%), 83.04 g of 2-hydroxyethyl acrylate, 346.0 g of styrene, 193.41 g of 2-ethylhexyl acrylate, 0.050 g of octyl mercaptopropionate, and 13.92 g of methacrylic acid was pumped into the reactor over 220 minutes. After the monomer emulsion addition was complete, an additional 7.5 g of water was pumped into the reactor. The water addition was followed by the addition of 1.0 g of ferrous sulfate solution (ferrous sulfate complexed with ethylenediaminetetraacetic acid (EDTA)). A solution of 1.7 g of t-butyl hydroperoxide dissolved in 20.0 g of water and a solution of 1.26 g of isoascorbic acid dissolved in 2.0 g of 28% ammonium hydroxide and 18.0 g of water were then pumped into the latex over 15 minutes. The latex was heated for an additional 20 minutes, and 28% ammonium hydroxide was then added to raise the pH to a value greater than 8. The resulting latex was filtered through a 100-mesh wire screen. The following data was recorded for the latex: dried solids collected through the 100-mesh screen (0.21 g); percent solids in latex (43.4%); pH of latex (8.9); Mn (20,610); Mw (290,100); particle size (141 nm (Dn)); Tg (51° C.); and minimum film formation temperature (32.2° C.).

### Example 2

### Preparation of a Latex with a Conventional Surfactant

To a 3000 mL resin kettle equipped with a nitrogen purge, three-blade impeller, and condenser were charged 521.0 g of water and 1.53 g Aerosol® OT-75 a brand of non-vinyl-containing surfactant (sodium dioctyl sulfosuccinate) available from American Cyanamid Company (Parsippany, N.J.). The surfactant solution was heated to 80° C. with stirring, and 3.2 g of ammonium persulfate dissolved in 40.0 g of water was then pumped into the reactor over 5 minutes followed by addition of 7.5 g of water. An emulsion feed of 280 g of water, 8.87 g of Aerosol® OT-75 brand non-vinyl-containing surfactant, 83.04 g of 2-hydroxethyl acrylate, 346.0 g of styrene, 193.41 g of 2-ethylhexyl acrylate, 0.050 g of octyl mercaptopropionate, and 13.92 g of methacrylic acid was pumped into the reactor over 220 minutes. After the monomer emulsion addition was complete, an additional 7.5 g of water was pumped into the reactor. The water addition was followed by the addition of 1.0 g of a ferrous sulfate solution (ferrous sulfate complexed with EDTA). A solution of 1.7 g of t-butyl hydroperoxide dissolved in 20.0 g of water and a solution composed of 1.26 g of isoascorbic acid dissolved in 2.0 g of 28% ammonium hydroxide and 18.0 g of water were then pumped into the latex over 15 minutes. The latex was heated for an additional 20 minutes, and 28% ammonium hydroxide was then added to raise the pH to a value greater than 8. The latex was then filtered through a 100-mesh wire screen. The following data was recorded for the latex: dried solids collected through the 100-mesh screen (0.21 g); percent solids in latex (43.0%); pH of latex (8.0); Mn (25,010); Mw (378,500); particle size (204 nm (Dn)); Tg (49° C.); and minimum film formation temperature (36.5° C.).

### Example 3

### Preparation of Coating Compositions From Latexes Prepared in Examples 1 and 2

A white-pigmented paint formulation was prepared using the latex prepared in Example 1 as a binder. A similar formulation was prepared using the latex prepared in Example 2. The formulations were prepared by producing a dispersion of 5.01 g of water; 1.08 g of CT-324, a brand of dispersant available from Air Products (Allentown, Pa.); 0.14 g of BYK 020, a brand of defoaming agent available from BYK Chemie (Wallingford, Conn.); and 21.03 g of TiPure™ R-900, a brand of TiO₂ pigment available from E.I. DuPont de Nemours (Wilmington, Del.). The CT-324 and BYK 020 were first added to the water under moderate agitation (approximately 50-100 rpm). The pigment was then added at about 100 rpm until it was fully incorporated such that there was no dry pigment on the surface of the mixture. Next, the mixture was dispersed using a Cowles blade at a blade speed of 3000 rpm to a value of 7.0 Hegman. Hegman is a unitless scale used to measure the fineness of a pigment dispersion. The Hegman grind gauge is a square metal bar with a well that gets progressively deeper on moving from the top to the bottom. A sample of paint was drawn along the well. Particles are deposited at a particular well depth depending on the size of the particle. The Hegman scale denotes the distance from the beginning of the well (the shallow end) to the end of the well (the deepest end). A reading of 7.0 Hegman means that the size of the dispersed pigment particles are about 15μ. After dispersion, the other components were added to the resulting mixture with vigorous stirring. First, 54.67 g of the latex of Example 1 or Example 2 was added to the mixture. Next, a premixed mixture of 10.14 g of Cymel® 303, a brand of melamine-based crosslinking agent available from Solutia (St. Louis, Mo.); 2.43 g of Ektasolve® EB, a brand of 2-butoxyethanol available from Eastman Chemical (Kingsport, Tenn.); and 5.34 g water was added to the mixture. Finally, 0.11 g Raybo™, a brand of flash rust inhibitor available from Raybo Chemical Co. (Huntington, W. Va.) and 0.05 g of Tafigel® PUR 40, a brand of associative thickener available from King Industries (Norwalk, Conn.) were added. The melamine-based crosslinking agent to polymer solids ratio was 30:70 by weight. Table 1 provides a list of the quantity of each of the ingredients in the coating compositions prepared using the latexes of Examples 1 and 2.

TABLE 1
Paint Formulations Prepared Using the Latexes Prepared in Examples
1 and 2.

| | | |
|---|---|---|
| | Amount of | Amount of |
| | Component in | Component in |
| | Composition | Composition |
| | Prepared From | Prepared From |
| | Latex of | Latex of |
| Components | Example 1 | Example 2 |

| Water | 5.01 | g | 5.01 | g |
|---|---|---|---|---|
| CT-324^{a} | 1.08 | g | 1.08 | g |
| BYK 020^{b} | 0.14 | g | 0.14 | g |
| TiPure ™ R-900^{c} | 21.03 | g | 21.03 | g |
| The above components were dispersed with high speed to 7.0 | | | | |
| Hegman. The following components were then added to the | | | | |
| mixture. | | | | |
| Example 1 Latex | 54.67 | g | 0.00 | g |
| Example 2 Latex | 0.00 | g | 54.67 | g |
| The following 3 components were premixed and then added to | | | | |
| the above mixture. | | | | |
| Cymel ® 303^{d} | 10.14 | g | 10.14 | g |
| Ektasolve ® EB^{e} | 2.43 | g | 2.43 | g |
| Water | 5.34 | g | 5.34 | g |
| Raybo ™ 60^{f} | 0.11 | g | 0.11 | g |
| Tafigel ® PUR 40^{g} | 0.05 | g | 0.05 | g |
| Total | 100.00 | g | 100.00 | g |

^{a}a brand of dispersant available from Air Products (Allentown, PA).
^{b}a brand of defoaming agent available from CYK Chemie (Wallingford, CT).
^{c}a brand of TiO₂ pigment available from E.I. DuPont de Nemours (Wilmington, DE).
^{d}a brand of melamine-based crosslinking agent available from Solutia (St. Louis, MO).
^{e}a brand of 2-butoxyethanol available from Eastman Chemical (Kingsport, TN).
^{f}a brand of flash rust inhibitor available from Raybo Chemical Co. (Huntington, WV).
^{g}a brand of associative thickener available from King Industries (Norwalk, CT).

### Example 4

### Evaluation of Coatings Prepared in Example 3

A BYK-Gardner gradient oven was used to evaluate the cure response of each coating prepared in Example 3. In the BYK-Gardner gradient oven, there are 45 different temperature elements that can each be set at specific, independent temperatures. In the gradient study, the first element was set to the lowest temperature with each subsequent heating element getting progressively higher in temperature. The range of the oven was set so that the first heating element was 120° C. and the last heating element was 180° C. The untreated steel panels that were coated for testing were long enough to contact all 45 heating elements. A small square drawdown bar was used to apply the coating compositions to the metal panels.

The coatings prepared in Example 3 were each drawn down the length of a steel panel using a 75μ square drawdown bar. The coatings were allowed to flash for five minutes under ambient conditions. The coated panels were then inserted into the BYK-Gardner gradient oven and allowed to bake for five minutes. The panels were then removed from the oven and cooled.

Methyl ethyl ketone double rubs were performed at regions of the drawdown bar, corresponding to specific temperatures as set by the gradient oven. Methyl ethyl ketone double rubs were performed using a piece of cheesecloth rubber-banded to the round end of a balpeen hammer. The cheesecloth was saturated with methyl ethyl ketone. Double rubs were performed by allowing the saturated cheesecloth to contact the coating. The hammer was grasped by the handle and the cheesecloth was moved back and forth across the coating. The only weight applied to the cheesecloth was from the mass of the hammer head. One back and forth motion constituted a double rub. The test was deemed complete when either a break through occurred in the coating or 200 double rubs were completed. The cheesecloth was resaturated with methyl ethyl ketone after every 50 rubs. The results from the methyl ethyl ketone double rub evaluation are presented in Table 2.

TABLE 2
Comparison of Number of MEK Double Rubs for Metal Coated with
Composition Containing Vinyl-Containing Surfactant Monomer and
Conventional Surfactant.

| | Number of MEK | |
|---|---|---|
| | Double Rubs | Number of MEK |
| | (Example 3 Polymer with | Double Rubs |
| | Vinyl-Containing | (Example 3 Polymer with |
| Temperature | Surfactant Monomer) | Conventional Surfactant) |
| 125° C. | 120 | 50 |
| 135° C. | 200 | 140 |
| 148° C. | 200+ | 200+ |

The data shown in Table 2 demonstrates the drastically improved solvent resistance of the coatings with the melamine-based aminoplast crosslinking agents containing vinyl-containing surfactant monomers over those containing conventional surfactants. Table 2 also shows that the coatings prepared from polymeric particles incorporating the vinyl-containing surfactant monomer provide better curing at lower temperatures as indicated by the results obtained at 125° C. A catalyst (1% by weight Nacorr® 1552, a brand of the zinc salt of dinonylnaphthalene sulfonic acid available from King Industries, Inc. of Norwalk, Conn.) was added to the coating compositions with vinyl-containing surfactant monomer prepared in Example 3 to determine what effect the addition of the catalyst would have on solvent resistance for the new Hitenol™ BC-20/Cymel® 303 containing coating composition. Experiments were carried out using the procedure described above with the formulations containing the catalyst. Table 3 shows that addition of the catalyst drastically improved solvent resistance, and allows for the preparation of coatings with higher solvent resistance at lower temperature. The same procedure was accomplished with the coating of Example 3 that contained the conventional surfactant, Aerosol® OT-75, to prepare and test coatings with the Nacorr® 1552 brand catalyst. The results are shown in Table 4. A comparison of Table 3 with Table 4 shows that while the addition of the curing catalyst improves the solvent resistance for the coatings at any given cure temperature, the solvent resistance is significantly higher for a given cure temperature for the novel coatings that contain the latex incorporating the vinyl-containing surfactant monomer as compared with that containing the conventional surfactant. For example, the number of MEK double rubs at 123° C. for the coating composition with the conventional surfactant and the Nacorr® 1552 brand catalyst was 80 whereas the number of double rubs at 113° C. for the similar coating with the vinyl-containing surfactant monomer was 160. Thus, the number of double rubs is more than twice that of the coating with the conventional surfactant even though the temperature is lower. The data contained in Tables 2 through 4 is graphically illustrated in the FIGURE.

TABLE 3
Comparison of Number of MEK Double Rubs for Metal Coated with
Composition Containing Vinyl-Containing Surfactant Monomer and
Coating Composition Containing Vinyl-Containing Surfactant Monomer
and Nacorr ® 1552 Brand Curing Catalyst

| | | Example 3 Polymer with |
|---|---|---|
| | Example 3 Polymer with | Vinyl-Containing |
| | Vinyl-Containing | Surfactant Monomer and |
| Temperature | Surfactant Monomer | Nacorr ® 1552 |
| 113° C. | 19 | 160 |
| 120° C. | 70 | 200+ |
| 135° C. | 200 | 200+ |

TABLE 4
Number of MEK Double Rubs for Metal Coated with Composition
Containing Conventional Surfactant Monomer and Nacorr ® 1552 Brand
Curing Catalyst

| | Example 3 Polymer with Conventional |
|---|---|
| Temperature | Surfactant and Nacorr ® 1552 |
| 123° C. | 80 |
| 135° C. | 140 |
| 150° C. | 200+ |

### Example 5

### Preparation and Evaluation of Can Coating Composition

The interior of an aluminum can of the type typically used in soft drinks was coated with a coating composition and then the performance of the coating was evaluated. The coating was prepared using a latex prepared as described in Example 1 using the procedure described below.

A mixture of 92.4 g Cymel® 303 brand melamine-derived crosslinking agent; 9.5 g Nacorr® 1552 brand curing catalyst, 113.8 g Ektasolve® EB brand 2-butoxyethanol; 120.2 g water and 1.1 g diethanolamine were premixed and then added with mixing to 510.3 g of the hydroxy-functional latex prepared as described above. After addition was complete, 4.0 g of L-493, a brand of defoaming agent available from Ashland Chemical (Booton, N.J.), and 0.9 g Tafigel® associative thickener were added with mixing.

The coating prepared as described above was applied to the inside of aluminum cans using a standard pilot plant size can coater. After coating, the cans were placed in a three-stage oven for 40 seconds to achieve a peak temperature of approximately 188° C. The final mass of the dried films for each can was approximately 150 mg.

Several tests were conducted on the coated cans. Methyl ethyl ketone double rubs were performed on the coatings. In these tests, cheesecloth was saturated with methyl ethyl ketone and the cloth was dragged back and forth across the coating surface with uniform pressure. The same method was used to study the coating on a can coated with a commercially available coating. The experimental coating showed no breakthrough after 50 double rubs with the methyl ethyl ketone saturated cloth whereas breakthrough was observed on the can with the commercially available coating.

Tests were conducted to determine the resistance of the coating to hot water. To perform these tests, a coated can was first cut into strips. The strips were placed in a beaker of water heated at 71° C. for a period of 30 minutes. The coating was then evaluated for blushing or any other change in appearance. No change of appearance was observed upon exposure to the hot water.

Tests were also performed to determine the resistance of the coating to aqueous phosphoric acid solutions. For these tests, several drops of 2N phosphoric acid were applied to the coating and allowed to remain for 1 hour. Once the reagent was removed, the coating was examined to detect any changes in the appearance of the coating. No changes in appearance were observed indicating that the coating composition resists low pH beverages such as cola.

A Ball Deformation test was performed on the coated cans. The test was performed by first placing a 3.5 square inch uncoated aluminum square into an Erichsen Ball Punch. The ball punch was lubricated with petroleum jelly, and the ball punch was set to a speed of approximately 0.5 inches per minute. The apparatus was run on the uncoated aluminum square until the test panel fractured. The time that it took to fracture the uncoated aluminum test panel was recorded. Next, a coated panel was placed in the testing apparatus. The apparatus was run for 10 seconds less than the test time needed to fracture the blank uncoated panel. After the panel was removed, Scotch® 250 brand adhesive tape was applied to the deformed area of the coated panel. The tape was then quickly removed, and both the tape and the deformed area were inspected for removed coating. The test panel was then exposed to a copper sulfate solution for a period of 20 minutes. Aluminum is known to turn dark when contacted with a copper sulfate solution and thus a copper sulfate solution was used to visualize any breaks in the coating. The results showed that no coating was removed during the tape removal test. Additionally, no breaks in the coating were observed after exposure to the copper sulfate solution as a result of the Ball Deformation test.

While only a few, preferred embodiments of the invention have been described, those of ordinary skill in the art will recognize that the embodiment may be modified and altered without departing from the central spirit and scope of the invention. Thus, the preferred embodiments described above are to be considered in all respects as illustrative and not restrictive, the scope of the invention being indicated by the following claims, rather than by the foregoing description, and all changes which come within the meaning and range of equivalents of the claims are intended to be embraced.

What is claimed is:

1. A coating composition, comprising:
(a) polymeric particles comprising at least one incorporated monoalkenyl aromatic monomer, at least one incorporated vinyl-containing surfactant monomer, and at least one incorporated acrylic monomer, wherein at least one incorporated acrylic monomer comprises a hydroxyl functional group, a carboxylic acid functional group, or an amide functional group;
(b) a crosslinking agent comprising an aminoplast resin; and
(c) water.

2. The coating composition according to claim 1, wherein the vinyl-containing surfactant monomer has the structure: 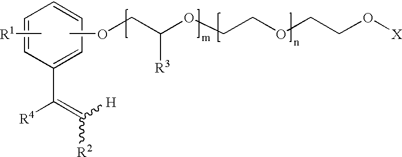
wherein R¹ is H, a halogen, or a C₁ to C₂₂ linear or branched chain hydrocarbon group; R² is H, a halogen, or a linear or branched chain C₁ to C₆ linear or branched chain hydrocarbon; R³ is H, a halogen, or a C₁ to C₆ linear or branched chain hydrocarbon group; R⁴ is H or a C₁ to C₄ alkyl group; m is an integer ranging from 0 to 20; n is an integer ranging from 1 to 50; X is H, SO₃⁻Y, P(═O)(OH)₂, or a deprotonated form of P(═O)(OH)₂; and Y is a cation selected from the group consisting of sodium, lithium, potassium, ammonium, monoalkylammonium, dialkylammonium, trialkylammonium, tetralkylammonium, and combinations thereof.

3. The coating composition according to claim 2, wherein the monoalkenyl aromatic monomer is styrene or α-methylstyrene and the polymeric particles incorporate an acrylic monomer selected from the group consisting of esters of acrylic acid, esters of methacrylic acid, and combinations thereof.

4. The coating composition according to claim 2, wherein the polymeric particle further comprises incorporated 2-ethylhexyl acrylate.

5. The coating composition according to claim 2, wherein the acrylic monomer comprises 2-hydroxyethyl acrylate or 2-hydroxyethyl methacrylate.

6. The coating composition according to claim 2, wherein the acrylic monomer comprises methacrylic acid or acrylic acid.

7. The coating composition according to claim 2, wherein the polymeric particle comprises incorporated styrene, incorporated 2-ethylhexyl acrylate, incorporated 2-hydroxyethyl acrylate, and incorporated methacrylic acid.

8. The coating composition according to claim 1, wherein the aminoplast resin comprises an organic aromatic compound comprising at least two functionalities selected from the group consisting of (alkoxymethyl)(hydroxymethyl)amines, di(hydroxymethyl)amines, di(alkoxymethyl)amines, and combinations thereof.

9. The coating composition according to claim 8, wherein the organic aromatic compound is a 1,3,5-triazine substituted with at least two functionalities selected from the group consisting of (alkoxymethyl)(hydroxymethyl) amines, di(hydroxymethyl)amines, di(alkoxymethyl)amines, and combinations thereof.

10. The coating composition according to claim 8, wherein the organic aromatic compound is a condensation product of melamine and six aldehyde molecules.

11. The coating composition according to claim 8, wherein the organic aromatic compound has the structure: 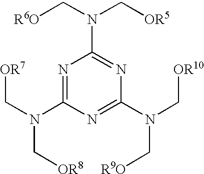
wherein R⁵, R⁶, R⁷, R⁸. R⁹ and R¹⁰ may be the same or different and are independently selected from the group consisting of H and alkyl groups having from 1-4 carbon atoms.

12. The coating composition according to claim 2, wherein the pH of the coating composition is greater than about 8.

13. The coating composition according to claim 2, wherein m is 0; n is an integer from 5 to 25; R² is methyl or H; R³ is H; R⁴ is H; and X is SO₃⁻Y.

14. The coating composition according to claim 13, wherein n is 19, m is 0, and Y is selected from the group consisting of ammonium, monoalkylammonium, dialkylammonium, trialkylammonium, and tetraalkylammonium cations.

15. The coating composition according to claim 2, wherein the coating composition further comprises a curing catalyst selected from the group of aromatic sulfonic acids and salts of aromatic sulfonic acids.

16. A coated substrate, comprising:
a substrate coated with the coating composition according to claim 15.

17. The coated substrate according to claim 16, wherein the substrate is metal.

18. The coated substrate according to claim 16, wherein the coating composition is crosslinked.

19. The coated substrate according to claim 16, wherein the substrate is a can having an interior surface, and the interior surface of the can is coated with the coating composition.

20. The coated substrate according to claim 19, wherein the coating composition is crosslinked.

21. The coating composition according to claim 15, wherein the curing catalyst is selected from the group consisting of benzenesulfonic acid, p-toluenesulfonic acid, dinonylnaphthalenesulfonic acid, and salts and mixtures thereof.

22. The coating composition according to claim 15, wherein the curing catalyst comprises a transition metal salt of an aromatic sulfonic acid.

23. The coating composition according to claim 22, wherein the curing catalyst comprises a zinc salt of dinonylnaphthalenesulfonic acid.

24. The coating composition according to claim 1, wherein the polymeric particles are substantially free of acetoacetoxy, amine, and enamine functionalities.

25. The coating composition according to claim 1, wherein the polymeric particles are substantially free of incorporated trimethylolpropane triacrylate.

26. The coating composition according to claim 1, further comprising an additive selected from the group consisting of a pigment, a defoaming agent, a flash rust inhibitor, an associative thickener, a dispersing agent, and combinations of these.

27. The coating composition according to claim 1, wherein the coating composition is crosslinked.

28. A coated substrate, comprising:
a substrate coated with the coating composition according to claim 1.

29. The coated substrate according to claim 28, wherein the substrate is metal.

30. The coated substrate according to claim 28, wherein the substrate is a can having an interior surface, and the interior surface of the can is coated with the coating composition.

31. The coated substrate according to claim 30, wherein the coating composition is crosslinked.

32. The coated substrate according to claim 28, wherein the coating composition is crosslinked.

33. A kit for preparing a coating composition, comprising:
(a) polymeric particles comprising at least one incorporated monoalkenyl aromatic monomer, at least one incorporated vinyl-containing surfactant monomer, and at least one incorporated acrylic monomer, wherein at least one incorporated acrylic monomer comprises a hydroxyl functional group, a carboxylic acid functional group, or an amide functional group; and
(b) a crosslinking agent comprising an aminoplast resin.

34. The kit for preparing a coating composition according to claim 33, wherein the aminoplast resin comprises an organic aromatic compound comprising at least two functionalities selected from the group consisting of (alkoxymethyl)(hydroxymethyl)amines, di(hydroxymethyl)amines, di(alkoxymethyl)amines, and combinations thereof.

35. The kit according to claim 34, further comprising a curing catalyst selected from the group consisting of aromatic sulfonic acids, salts of aromatic sulfonic acids, and combinations thereof.

36. A method of preparing a coating composition, comprising:
mixing polymeric particles with a crosslinking agent to produce the coating composition, wherein the polymeric particles comprise at least one incorporated monoalkenyl aromatic monomer, at least one incorporated vinyl-containing surfactant monomer, and at least one incorporated acrylic monomer, wherein at least one incorporated acrylic monomer comprises a hydroxyl functional group, a carboxylic acid functional group, or an amide functional group and wherein the crosslinking agent comprises an aminoplast resin.

37. The method of preparing a coating composition according to claim 36, further comprising adding a curing catalyst selected from the group consisting of an aromatic sulfonic acid, a salt of an aromatic sulfonic acid, and mixtures thereof to the coating composition.

38. The method for preparing a coating composition according to claim 36, wherein the vinyl-containing surfactant monomer has the structure: 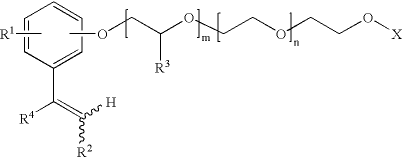
wherein R¹ is H, a halogen, or a C₁ to C₂₂ linear or branched chain hydrocarbon group; R² is H, a halogen, or a linear or branched chain C₁ to C₆ linear or branched chain hydrocarbon; R³ is H, a halogen, or a C₁ to C₆ linear or branched chain hydrocarbon group; R⁴ is H or a C₁ to C₄ alkyl group; m is an integer ranging from 0 to 20; n is an integer ranging from 1 to 50; X is H, SO₃⁻Y, P(═O)(OH)₂, or a deprotonated form of P(═O)(OH)₂; and Y is a cation selected from the group consisting of sodium, lithium, potassium, ammonium, monoalkylammonium, dialkylammonium, trialkylammonium, tetralkylammonium, and combinations thereof.

39. The method of preparing a coating composition according to claim 38, wherein m is 0; n is an integer from 5 to 25; R² is methyl or H; R³ is H; R⁴ is H; and X is SO₃⁻Y.

40. The method of preparing a coating composition according to claim 39, wherein n is 19 and Y is selected from the group consisting of ammonium, monoalkylammonium, dialkylammonium, trialkylammonium, and tetraalkylammonium cations.

41. The method of preparing a coating composition according to claim 36, wherein the aminoplast resin comprises an organic aromatic compound comprising at least two functionalities selected from the group consisting of (alkoxymethyl)(hydroxymethyl)amines, di(hydroxymethyl)amines, di(alkoxymethyl)amines, and combinations thereof.

42. The method of preparing a coating composition according to claim 41, wherein the organic aromatic compound is a 1,3,5-triazine substituted with at least two functionalities selected from the group consisting of (alkoxymethyl)(hydroxymethyl)amines, di(hydroxymethyl)amines, di(alkoxymethyl)amines, and combinations thereof.

43. The method of preparing a coating composition according to claim 41, wherein the organic aromatic compound has the structure: 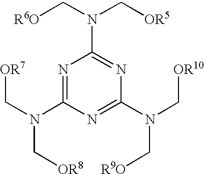
wherein R⁵, R⁶, R⁷, R⁸. R⁹ and R¹⁰ may be the same or different and are independently selected from the group consisting of H and alkyl groups having from 1-4 carbon atoms.

44. A method for preparing a crosslinked coating composition, comprising:
preparing a coating composition according to claim 36, and heating the coating composition to a temperature of greater than about 100° C.

45. The method for preparing a crosslinked coating composition according to claim 44, wherein the coating composition is heated to a temperature from 113° C. to 200° C.

46. The method for preparing a crosslinked coating composition according to claim 44, wherein the coating composition further comprises a curing catalyst.

47. The method for preparing a crosslinked coating composition according to claim 46, wherein the coating composition is heated to a temperature of from 113° C. to about 200° C.

48. A method for preparing a coated substrate, comprising:
coating a substrate with the coating composition according to claim 1 to provide a coated substrate.

49. The method for preparing a coated substrate according to claim 48, further comprising heating the coated substrate to a temperature of greater than 110° C.

50. The method for preparing a coated substrate according to claim 48, wherein the coating composition further comprises a curing catalyst.

51. The method for preparing a coated substrate according to claim 50, further comprising heating the coated substrate to a temperature of greater than about 100° C.

52. The method for preparing a coated substrate according to claim 51, wherein the substrate is metal.

53. The method for preparing a coated substrate according to claim 51, wherein the substrate is a can having an inner surface, and the coating composition is coated on the inner surface of the can.

54. The method for preparing a coated substrate according to claim 48, wherein the substrate is a can having an inner surface, and the coating composition is coated on the inner surface of the can.

55. A method for preparing a coated substrate, comprising:
coating a substrate with the coating composition according to claim 8 to provide a coated substrate.

56. A waterborne composition comprising:
water, polymeric particles, a crosslinking agent, and a zinc salt of dinonylnaphthalenesulfonic acid.
